(19) United States
(12) Patent Application Publication
(10) Pub. No.: US 2014/0349572 A1
(43) Pub. Date: Nov. 27, 2014

(54) INTEGRATED INDUCTIVE POWER RECEIVER AND NEAR FIELD COMMUNICATOR

(71) Applicant: POWERMAT TECHNOLOGIES LTD., Neve Ilan (IL)

(72) Inventors: Amir BEN-SHALOM, Modiin (IL); Yoel RAAB, Hod HaSharon (IL); Rotem SHRAGA, Kiryat Ono (IL); Arye NUDELMAN, Jerusalem (IL); Ilya GLUZMAN, Holon (IL)

(21) Appl. No.: 14/323,957

(22) Filed: Jul. 3, 2014

Related U.S. Application Data
(63) Continuation of application No. PCT/IL2013/050011, filed on Jan. 3, 2013.
Application No. PCT/IL2013/050011 is a continuation-in-part of application No. 13/053,857, filed on Mar. 22, 2011.
Application No. 13/053,857 is a continuation of application No. PCT/IL2009/000915, filed on Sep. 22, 2009.
(60) Provisional application No. 61/583,390, filed on Jan. 9, 2012.
(60) Provisional application No. 61/583,392, filed on Jan. 5, 2012.
(60) Provisional application No. 61/673,839, filed on Jul. 20, 2012.
(60) Provisional application No. 61/136,660, filed on Sep. 23, 2008.

(51) Int. Cl. H04B 5/00; H02J 7/02

(52) U.S. Cl. CPC H04B 5/0037; H04B 5/0081; H02J 7/025
USPC 455/41.1; 320/137

(57) ABSTRACT

A combined inductive power receiving system and method for selectively providing at least one of power and communication reception. The combined inductive power receiving system comprises at least one inductive power receiver module configured to couple with at least one Near Field Communication (NFC) module possibly using a combined communication antenna. The inductive receiver module may comprise a power reception circuit operable to receive power from a secondary inductor and to provide power to an electric load; a selection switch operable to allow transmission of wireless power from the secondary inductor to the power reception circuit; and a matching circuit operable to filter transmission of NFC signals to the NFC reader module.

### CROSS-REFERENCE TO RELATED APPLICATIONS

This application is a continuation of PCT/IL2013/050011 filed Jan. 3, 2013 which claims the benefit of U.S. Provisional Application Ser. No. 61/583,392 filed Jan. 5, 2012; 61/583,390 filed Jan. 9, 2012; and 61/673,839 filed Jul. 20, 2012, and is also a continuation-in-part of U.S. application Ser. No. 13/053,857 filed Mar. 22, 2011, which is a continuation of PCT/IL2009/000915 filed Sep. 22, 2009 which claims the benefit of U.S. Provisional Application Ser. No. 61/136,660 filed Sep. 23, 2008, the disclosures of which are hereby incorporated by reference in their entirety herein.

### TECHNICAL FIELD

The disclosure herein relates to inductive power receivers. In particular, the disclosure relates to combined Near Field Communication and inductive receiver circuits.

### BACKGROUND

Near Field Communication (NFC) enables data to be exchanged between devices over short distances of up to about 10 centimeters or so. NFC is essentially an extension of Radio Frequency Identification (RFID) technology which integrates a smartcard and reader into a single device. Consequently, NFC is compatible with contactless infrastructure as used for payment on public transport systems, for example.

NFC technology is particularly suited for transferring data to and from cellular telephones fitted with NFC readers. Apart from its compatibility with existing RFID devices, NFC has a number of advantages over Bluetooth technology and the like. Notably, NFC does not require manual configurations of the communicating devices and so has a much shorter set-up time than other technologies.

A further feature of NFC is that an NFC reader may behave as a transponder with the NFC antenna drawing energy from the incoming electromagnetic signal by electromagnetic induction. Thus, for example, data may be transferred to an NFC-enabled mobile phone, even when the phone is switched off.

Electromagnetic induction allows energy to be transferred from a power supply to an electric load without requiring a conduction path therebetween. A power supply is wired to a primary coil, and an oscillating electric potential is applied across the primary coil, thereby inducing an oscillating magnetic field. The oscillating magnetic field induces an oscillating electrical current in a secondary coil placed within this field. Thus, electrical energy may be transmitted from the primary coil to the secondary coil by electromagnetic induction, without the two coils being conductively connected. When electrical energy is transferred from a primary coil to a secondary coil in this manner, the pair is said to be inductively coupled. An electric load wired in series with such a secondary coil may draw energy from the power source when the secondary coil is inductively coupled to the primary coil.

### SUMMARY

It is according to one aspect of the current disclosure to present a combined inductive power receiving system for selectively providing at least one of power and communication reception. The combined inductive power receiving system comprising: at least one inductive power receiver module configured to couple with at least one Near Field Communication (NFC) module possibly using a combined communication antenna. The inductive receiver module may comprise a power reception circuit operable to receive power from a secondary inductor and to provide power to an electric load; a selection switch operable to allow transmission of wireless power from the secondary inductor to the power reception circuit, and a matching circuit operable to filter transmission of NFC signals to the NFC reader module.

Where appropriate, the combined communication antenna may be operable at a range of frequencies for receiving NFC and power signals concurrently and/or separately.

Optionally, the inductive power receiver module comprises the combined communication antenna. Additionally or alternatively, the NFC reader module comprises the combined communication antenna.

Optionally, the combined communication antenna is configured to split signals of inductive power reception and near field communication transmission and may optionally comprise a common single coil antenna.

Optionally, the combined communication antenna comprises at least one inductive power receiver secondary inductor and at least one near field communication antenna.

Optionally, the inductive power receiver module further comprises a control circuit.

Optionally, the NFC reader module may be externally coupled and operable at an approximately near field communication transmission frequency, where the range of operable frequencies is between 270 KHz to 360 KHz and 110 KHz to 205 KHz for inductive power reception and near field communication transmission frequency for NFC communication which is of 13.56 MHz.

Additionally or alternatively, the receiving system is configured to block damaging signal transmission to NFC circuit by isolating the NFC circuit or by adding filters and may optionally, have a selection switch integrated in the NFC reader module. This selection switch optionally connects the combined communication antenna outputs to select manually between communication operation mode and power receiving operation mode. Additionally or alternatively, the selection switch controls the inductive power reception and the NFC reader by a passive selection switch connected to the combined communication antenna outputs. The selection switch may further be configured to prevent the NFC signal from reaching the inductive power reception branch through control signal from the control circuit. This control circuit optionally includes a low pass filter of which its output may trigger blocking the selection switch.

Optionally, the selection switch may further be configured to allow transmission of wireless power signal while blocking NFC signals with higher frequencies such as 13.56 MHz.

Optionally, the matching circuit further comprises a passive circuit configured to decrease inductive power transmission and may further comprise tuning elements and may be added to tune NFC circuit frequency to radio signals.

In a further embodiment of the invention, a mobile communication device comprises the inductive power receiving system. The mobile communication device may be selected from a group consisting of handheld devices, mobile phones, tablets, PDAs, media players and the like.

According to another aspect of the disclosure, a method is taught for charging an electrochemical cell of a communication device. The communication device, which may be a mobile telephone or the like, may comprise a near field communication antenna, a near field communication circuit, a power receiving circuit and a switching unit operable to selectively connect said communication circuit or said power receiving circuit to the near field communication antenna. The method may comprise the steps of: providing a rectification unit wired to the electrochemical cell; connecting the power receiving circuit to the near field communication antenna; and bringing the near field communication antenna into the vicinity of an operating inductive power outlet; such that a secondary voltage, induced in the near field communication antenna, may be rectified by said rectification unit, thereby providing a charging voltage for the electrochemical cell. It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram showing selected elements of a combined inductive power and NFC receiver system;

FIG. 2 illustrates a possible NFC reader module which may be integrated with a wireless power functionality module of the disclosure;

FIG. 3 is an illustration of a possible printed circuit board of a wireless power functionality module for integration with an NFC reader module;

FIG. 4 is a block diagram of a possible example of a combined power and NFC receiver system, including a connector to an NFC reader module;

FIG. 5 is a top view illustration of a combined power receiver and NFC receiver system;

FIGS. 6A and 6B represent various configurations for combined antennas for NFC and inductive power reception;

FIGS. 7A and 7B are circuit diagrams of a possible matching circuit and a possible control circuit for use in a wireless power functionality module such as described herein; and

FIG. 8 is a flowchart illustrating selected actions of a method for charging an electrochemical cell of a communication device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects of the present disclosure relate to combined Near Field Communication (NFC) and inductive receiver circuits.

Optionally, a single coil NFC & wireless power antenna may be configured to operate at frequencies around the range of 270-360 KHz and 110-205 KHz for wireless power and 13.56 MHz for NFC communication.

Both wireless charging and NFC communication may be provided on a common coil antenna possibly by splitting the inductive power signal to its circuit and NFC signal to its module. Additionally or alternatively, the NFC and the inductive power transmissions may operate in a time-division-mode (TDM) such that the two signals do not interfere with each other.

The antenna may be assembled onto an inductive power receiver such as those integrated into backdoors of mobile phones, retrofittable receiver units, skins or the like. It is further noted that the antenna may be integrated into retrofittable inserts or the like such as various platforms described in the applicants' co-pending patent application PCT/IL2012/050544 titled, “System and Method for Providing Wireless Power Transfer Functionality to an Electrical Device” which is incorporated herein by reference. Other electronic elements may be assembled on the main board of a mobile device by a third party. The shape of host electrical devices, such as telephones, tablet computers, media players or the like, and the interface of the antenna to the host electrical device may vary from model to model and customization may be provided for each model as required. Customization units may be provided as evaluation boards and accompanying reference design.

Variously, multiple antennas may be provided in parallel including at least one inductive power receiver secondary inductor and at least one NFC antenna. For example, two coils may be provided side by side, nested, one inside the other or the like.

Alternatively or additionally, a common antenna may be provided for both inductive power reception and NFC reception. Accordingly, a selection switch may be connected to the antenna outputs to select between the operations modes. Such a selection switch may be controlled by logic circuits, possibly integrated with the NFC or the induction power reception circuits.

In other embodiments, a common inductive power reception and NFC antenna may be controlled by a passive selection switch for both types of communication with a passive switch on the antenna outputs.

Where possible, the common antenna may be operable to receive power inductively and to receive NFC signals concurrently. Accordingly, filters and the like may be provided to protect circuit elements as appropriate.

It is noted that the system may prevent potential damage to the NFC circuit by the inductive power transmission, possibly by isolating the NFC circuit therefrom. The system may further prevent reading errors and the like which may be generated from interference to the NFC data from inductive power transfer signals.

In addition, the system may be configured to maintain uncompromised NFC or inductive power transmission functionality. In particular, the NFC reading capability may not be compromised due to using a wireless power matched antenna. Also, the wireless power transmission efficiency may not be compromised due to using an NFC matched antenna.

It will be appreciated that using a combined antenna reduces the footprint of the components and consequently, less real-estate is required than when using two different antennas.

It is noted that the systems and methods of the disclosure herein may not be limited in their application to the details of construction and the arrangement of the components or methods set forth in the description or illustrated in the drawings and examples. The systems and methods of the disclosure may be capable of other embodiments or of being practiced or carried out in various ways.

Alternative methods and materials similar to or equivalent to those described herein may be used in the practice or testing of embodiments of the disclosure. Nevertheless, particular methods and materials are described herein for illustrative purposes only. The materials, methods, and examples are not intended to be necessarily limiting.

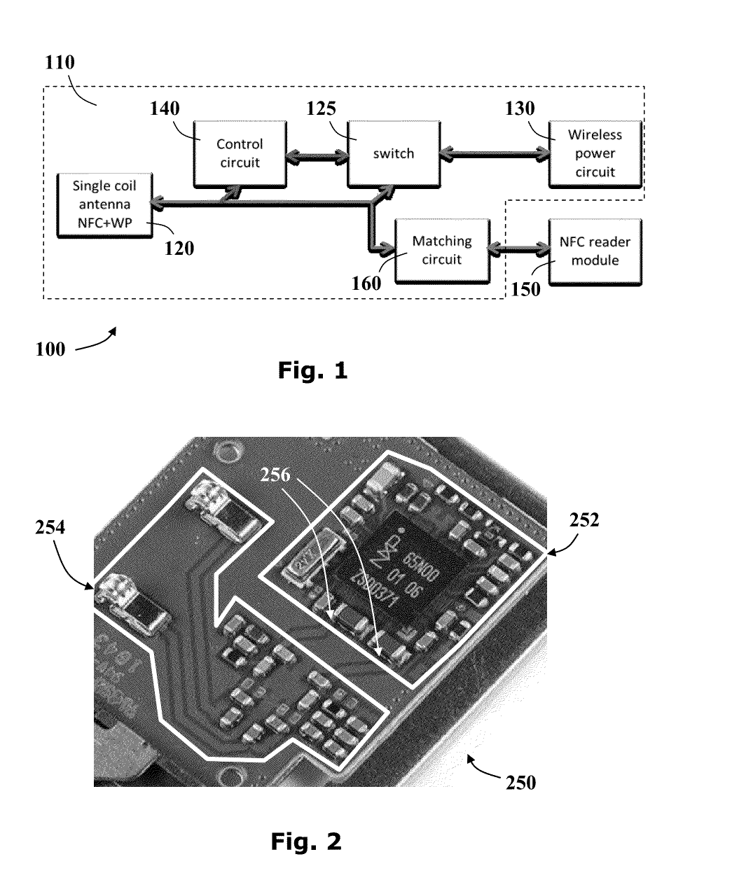

Reference is made to the block diagram of FIG. 1 showing selected elements of a system for providing combined inductive power and NFC reception. The system 100 includes a common NFC and inductive reception coil 120 configured to connect to either an inductive power reception circuit 130 and an NFC reader module 150. The system 100 comprises the NFC reader module 150 and a wireless power functionality module 110. The wireless power functionality module 110 may comprise a control circuit 140, a selection switch 125, a matching circuit 160 and the inductive power reception circuit 130.

In some embodiments, the common antenna 120 may be selectably connectable to the inductive power reception circuit 130 or the NFC reader module 150. Accordingly, the selection switch 125 may be biased to disconnect the inductive power reception circuit 130 from the antenna 120 until a wireless power communication is detected.

It is particularly noted that, where appropriate, the common antenna 120 may be connected to both the inductive power reception circuit 130 and the NFC reader module 150. The selection switch 125 may be operable to allow the transmission of a wireless power signal, while blocking NFC signals, which may have higher frequencies, say of 13.56 MHz. Indeed, it will be appreciated that such an arrangement may allow NFC signals to be received concurrently with a wireless power signal.

The common antenna 120 may be an inductor such as a coil antenna for providing NFC communication and wireless power selectively. A coil antenna having a magnet and ferrite, for example, may be embedded into an inductive power reception unit such as being incorporated into a battery cover, sleeve, skin or the like associated with handheld devices such as mobile phones, for example.

The selection switch 125 may be configured to prevent the NFC signal from reaching the inductive power reception branch. The switch 125 may be configured to be normally biased in the OFF state such that NFC communication is enabled. Once the inductive power transmission is initiated, the switch 125 may receive a control signal from the control circuit 140 triggering the switch 125 to move to the ON state. Alternatively switches may be used which are normally biased in the ON state such that the device is by default inductive power reception enabled as where required. Optionally, the bias of the switch may be manually or otherwise user selectable to suit requirements.

Accordingly, a switch 125 may be implemented as a MEMS component, a PIN diode, an IAC switch or the like which may be reflective and operable to block a signal when no supply current is applied. Other technologies may be used as required such as magnetic switches, filters, reed relay, GaAr, GaNi switches or the like and combinations thereof.

The control circuit 140 may be a passive circuit configured to provide a signal to the switch 125 only when an inductive power transmission signal is detected. Such a circuit may comprise a low pass filter or the like which produces an output signal only when signals are detected having frequencies associated with wireless power transmission.

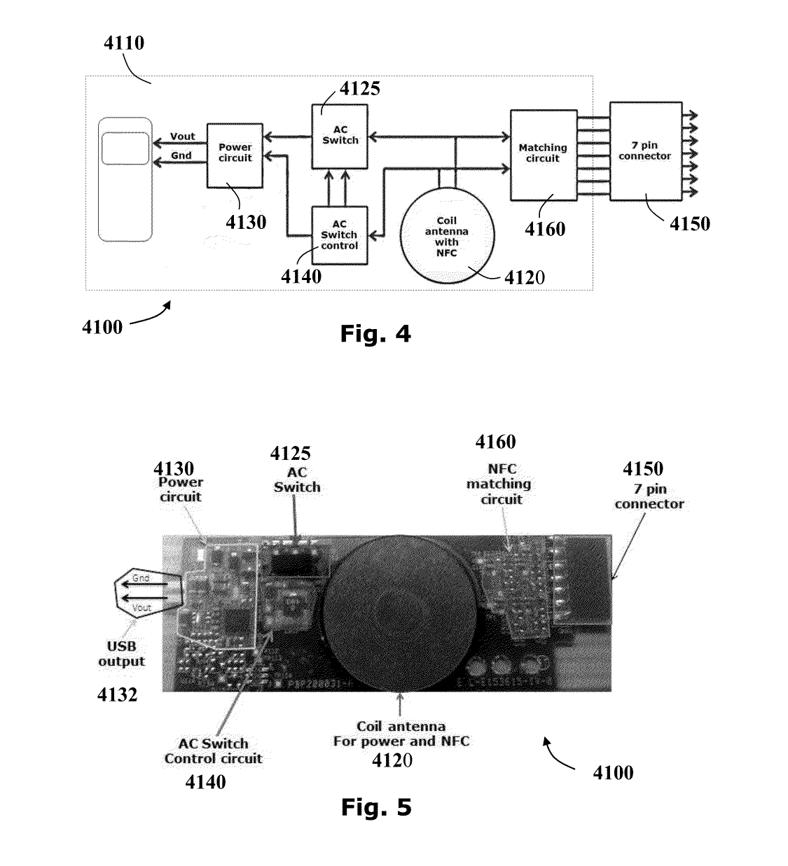

FIG. 4 and FIG. 5 show possible implementations of a combined power and NFC receiver system. The embodiments include a first connector for connecting to an NFC circuit such as a seven pin male connector, for example, of the PN544 chip often used in mobile phones. Additionally, the embodiments may include a second connector for connecting an inductive power charging circuit to a charging circuit of an electrical device, for example, via a charging connector, possibly a USB type connector for a mobile device.

Particular reference is made now to the block diagram of FIG. 4 showing selected elements of a possible combined power and NFC receiver system. A chip such as the PN544 chip may be responsible for the NFC protocol and has its own evaluation board possibly given by NXP. The sample application may be provided with a connector that enables connection to a PN544 Evaluation Board (EVB), thus allowing testing and developing NFC applications for it. The receiver system may further be provided with a USB connector 4132 or the like for connecting its wireless charging units to an electrical device, thus enabling the integrated dual functionality of the disclosure.

The system 4100 includes a common NFC and inductive reception coil antenna 4120, an inductive power reception PowerMat circuit 4130, an NFC reader module male connector 4150 and a wireless power functionality module 4110.

The inductive reception coil antenna 4120 may be configured to connect selectively to an inductive power reception circuit 4130 or an NFC reader module possibly through its 7 pin male connector 4150.

The wireless power functionality module 4110 may comprise an AC control switch 4140, an AC switch 4125, a matching circuit 4160 and the PowerMat circuit of inductive power reception 4130.

As described hereinabove, the NFC reader module connectivity, may be effected via a 7 pin connector 4150. Accordingly, the 7 Pins functionality, may be as described below:
1. Gnd: connecting the system to the ground of connected chip.
2. ANT1: + input connected to the matching circuit. It enables the battery off mode and allows the chip to operate as a tag when battery is not connected.
3. ANT2: − input same functionality as ANT1.
4. TX1: + output of the chip transmitter, the transmitted signal passes throw the EMI filter across the matching circuit and eventually arrives to the antenna.
5. TX2: − output of the chip transmitter the same functionality as TX1.
6. Vmid: the chip may sample this voltage for its Rx functionality, after the matching circuit and EMI filter the received signal arrives to Rx back signaling module that need to be tuned for each design
7. Vrx: the ratio between Vrx and Vmid, may allow the connected chip to process the received signal.

Reference is made to FIG. 5 showing an illustration of a top view of a combined power receiver and NFC with a PN544 NXP chip with a 7 pin male connector linking between the antenna and RF part to the PN544 chip periphery, on one side and a USB connector for applying its wireless charging abilities, on the other side.

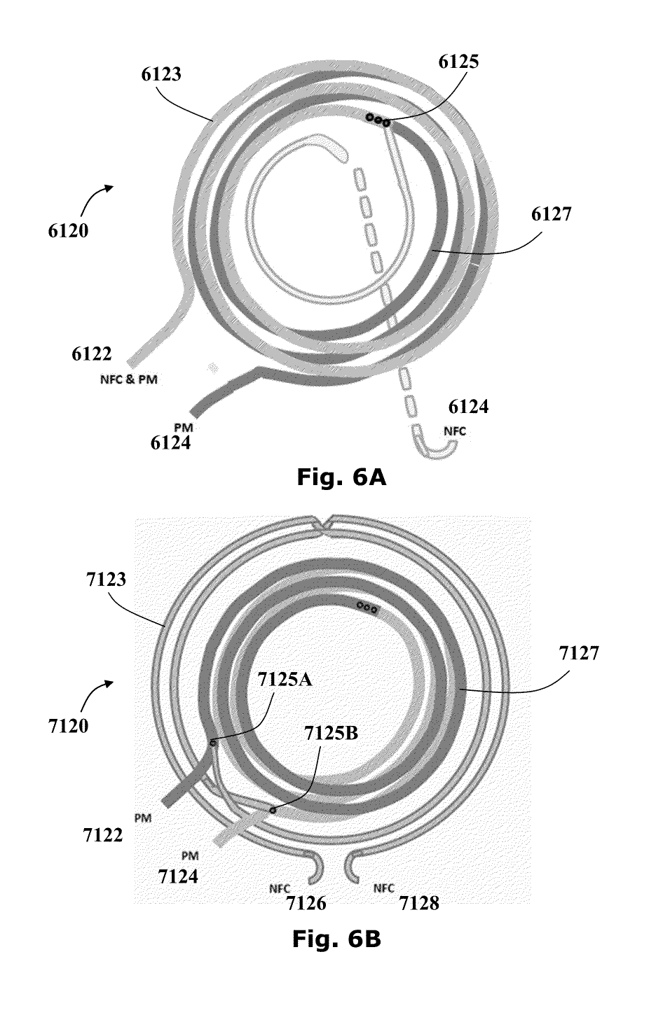

Reference is now made to FIG. 6A and FIG. 6B showing selected examples of possible common antenna connectivity configurations represented schematically by their diagrams.

Referring particularly to FIG. 6A, a common coil antenna 6120 may be provided with three terminals 6122, 6124, 6126. A first terminal 6122 may be a common terminal for both NFC and wireless power circuits. A second terminal 6124 may be a second wireless power circuit terminal. A third terminal 6126 may be an exclusively NFC terminal. It is noted that the third terminal 6126 may be connected to the common coil antenna at a mid-junction 6125 situated at some midway point along the common coil antenna 6120.

The first terminal 6122 may be wired to the control circuit, switch and matching circuit of a reception circuit such as described herein. The second terminal 6124 may be wired to the control circuit of the wireless power control module such as described herein. The third terminal 6126 may be wired to the matching circuit of the NFC reader module.

It is noted that the inductance of the wireless power coil 6127 as measured between the first and a second terminal may be different from the inductance of the NFC coil 6123 as measured between the first and third terminal. Accordingly the length of the common coil antenna 6120 of the common coil antenna 6120 may be selected such that the wireless power coil 6127 is tuned to receive signals at a wireless power transfer frequency. Similarly, the position of the mid-junction 6125 of the common coil antenna 6120 may be selected such that the NFC coil 6123 is tuned to receive signals at a NFC reception frequency.

Referring now to FIG. 6B, in another configuration a common coil antenna 7120 may be provided with four terminals 7122, 7124, 7126, and 7128. The first terminal 7122 and second terminal 7124 may be a pair of exclusively wireless power circuit terminals. The third terminal 7126 and fourth terminal 7128 may be a pair of exclusively NFC terminals. It is noted that the first terminal 7122 may be connected to the common coil antenna 6120 at a first mid-junction 7125A situated at a first midway point along the common coil antenna 7120 and the second terminal 7124 may be connected to the common coil antenna 7120 at a second mid-junction 7125B situated at a second midway point along the common coil antenna 7120.

The wireless power circuit terminals 7122, 7124 may be wired to the control circuit of the wireless power control module. The NFC terminals 7126, 7128 may be wired to the matching circuit of the NFC reader module.

Accordingly the length of the common coil antenna 7120 may be selected such that the NFC coil 7123 is tuned to receive signals at a NFC reception frequency and the position of the mid-junctions 7125A, 7125B of the common coil antenna 7120 may be selected such that the wireless power coil 7127 is tuned to receive signals at a wireless power transmission frequency.

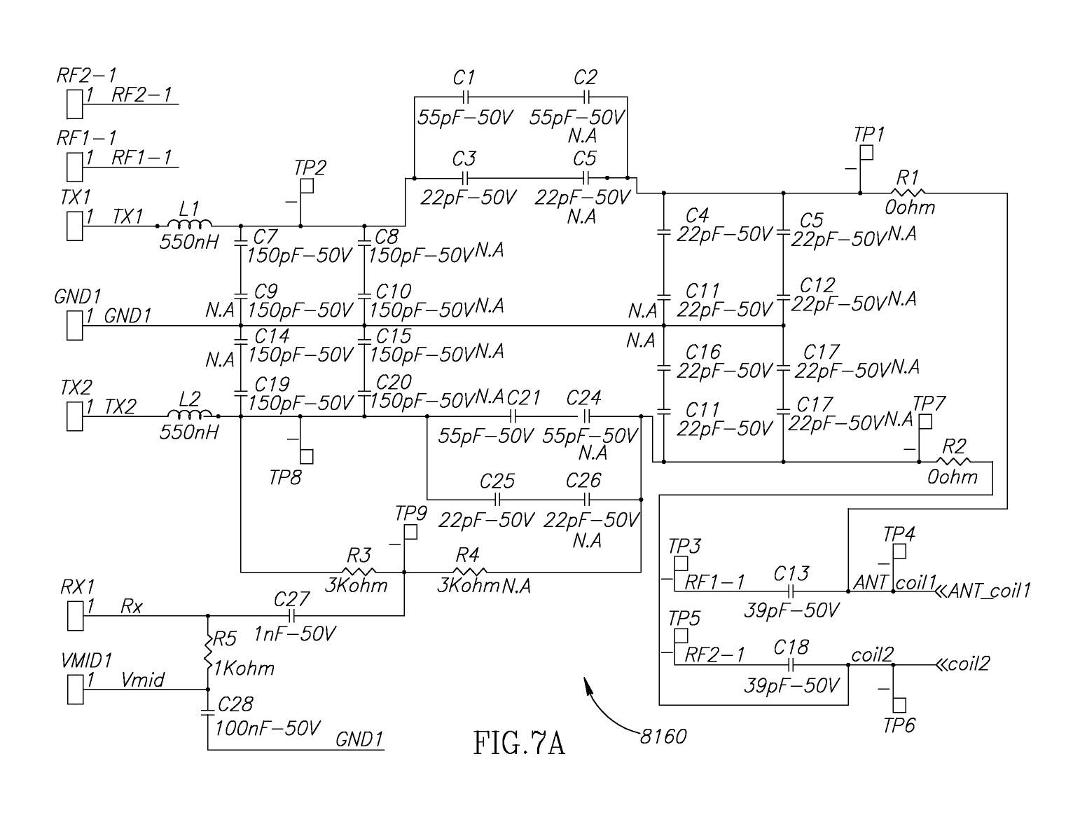

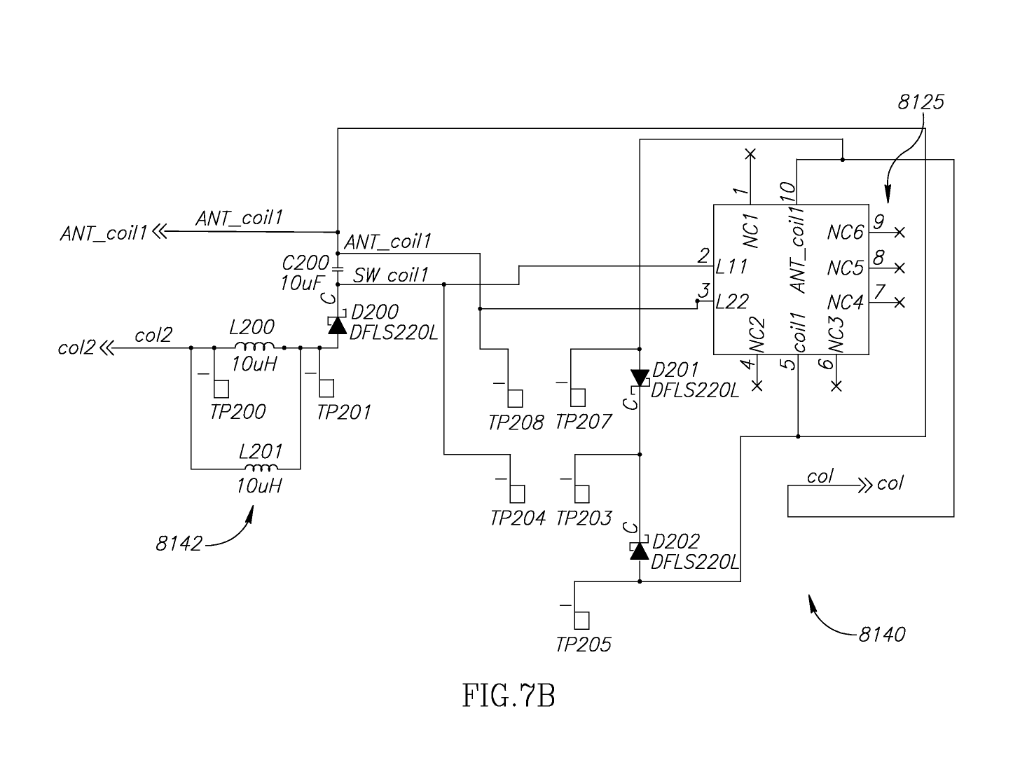

An example, of a possible control circuit 8140 and selection switch 8125 for use with the common NFC and inductive reception coil 120 is represented schematically by the circuit diagram of FIG. 7B. It is noted that the control circuit 8140 includes a low pass filter 8142 the output of which may trigger the switching block 8125.

The matching circuit 160 is provided to match the NFC reader module to received NFC signals. It is a particular feature of the current disclosure that the matching circuit 160 may further comprise a passive circuit configured to decrease an inductive power transmission signal and prevent it from damaging the NFC circuit. In addition, the matching circuit 160 may include tuning elements enabling it to function as a matching circuit of a NFC chip. Accordingly the matching circuit 160 reception unit may be integrated with an external NFC reader module 150 without a standard NFC matching circuit.

An example of a possible matching circuit 8160 for use with the common NFC and inductive reception coil 120 is represented schematically by the circuit diagram of FIG. 7A. It is noted that the matching circuit 8160 may function as a filter blocking the transmission of low frequency signals associated with inductive power transmission.

For illustrative purposes only, a selection of possible operating parameters is presented in the table below:

| | |
|---|---|
| Parameter | Value |

| Frequency range for WP Band | 110-205 KHz and 270-360 KHz | |
|---|---|---|
| BW of WP Band | 0-1 | MHz |
| Center Frequency NFC Band | 13.56 | MHz |
| BW of NFC Band | 12-15 | MHz |
| Power handling WP Band | 6 W | max. |
| Power handling NFC Band | 0.5 W | max |
| Out of band emission WP Band | 300 | (mV) |
| Out of band emission NFC Band | 100 | (mV) |

The inductive power reception circuit 130 may be provided incorporated into a wireless charging PCB. Such a reception circuit 130 may include various elements such as rectification units, smoothers, regulators, feedback circuits and the like as required.

The NFC reader module 150 may be provided to connect to an electrical device reader component of the art. Optionally the module 150 described herein may be operable to replace an analog section and antenna of an NFC reader module whilst retaining the features of the integrated circuit and its peripherals.

Referring now to FIG. 2, a reader module 250 is presented. The reader module 250 includes a reader circuit 252 including the integrated circuit and peripherals, a matching circuit 254 and connecting pins 256 therebetween.

Referring back now to FIG. 1, it is particularly noted that the wireless power functionality module 110 of the system 100 may be connected to the NFC reader module 250 by connecting the matching circuit 160 of the wireless power functionality module 110 directly to the connecting pins 256 of the reader circuit 252. Accordingly, the matching circuit 254 of the reader module 250 may be replaced by the wireless power functionality module 110.

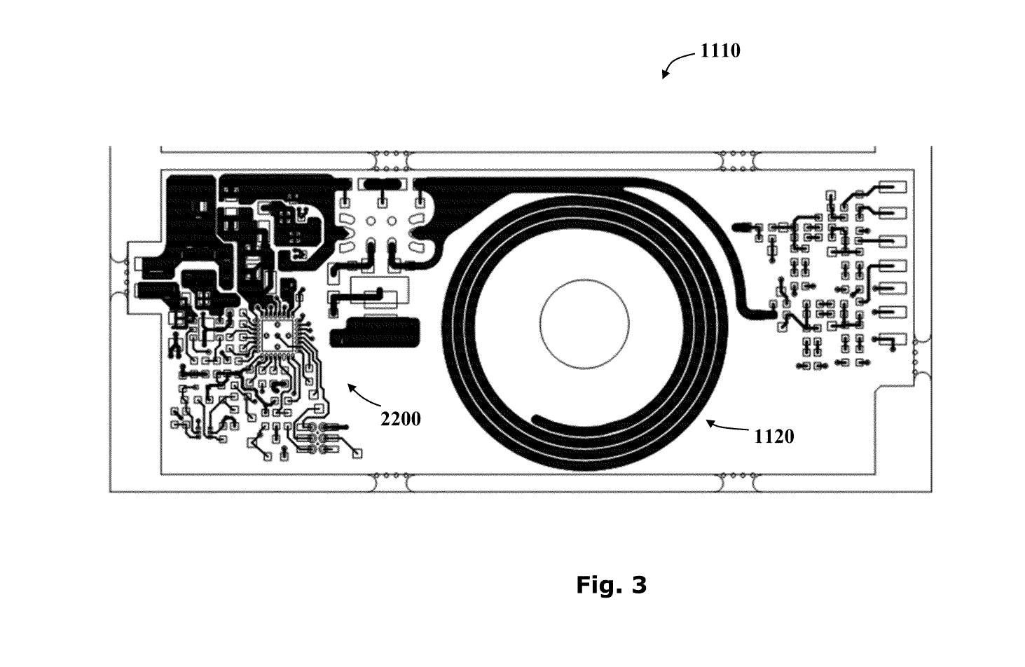

Accordingly all inductive power control elements may be manufactured as on a PCB for subsequent integration with an NFC circuit. FIG. 3 shows a possible PCB of a wireless power functionality module 1110 for integration with an NFC reader module including a common NFC and inductive reception coil 1120.

It is noted that the transmission frequencies used by Near Field Communication signals and inductive power signals are sufficiently close that concurrent NFC and inductive power transfer may interfere with each other. Accordingly, where appropriate, a combined NFC and inductive power transfer module may be operable in time-division-mode (TDM).

In time-division-mode, the combined NFC and inductive power transfer module may be operable to prevent concurrent communication of both signals, such that reception of signals of one type are interrupted while reception of the other signals is received.

It will be appreciated that NFC signals are generally of shorter duration and are more time critical than inductive power transfer signals. Accordingly, the NFC reader may be configured to serve as a master and operable to override the inductive power receiver ceasing inductive power transfer when appropriate. Alternatively, if the NFC was less time critical say, the inductive power receiver may be configured to serve as the master.

Optionally, a mutual logic control unit may be provided between the NFC reader and the inductive power receiver. The mutual logic control may be operable to instruct the inductive power receiver to interrupt power transmission, when an NFC signal is received.

In some cases, the incoming NFC communication may include a request signal, detectable by the combined NFC and inductive power transfer module. Receipt of the request signal may trigger the control unit to interrupt inductive power reception for the duration of the NFC communication. Optionally an end-of-communication (EOC) signal may be sent at the end of the NFC communication. The EOC signal may be used to trigger the control unit to resume inductive power reception.

Alternatively, where the NFC communication does not include a request signal, the NFC signal may be initially received concurrently with the inductive power transfer, for example, as a superimposed signal. Detection of the NFC communication may trigger the control unit to interrupt inductive power reception. When the NFC communication is no longer detected, the system may revert to inductive power transfer mode.

Accordingly, an NFC reader chip may be configured to include a pin providing a signal when a communication is received. Such an output pin may be used to interrupt inductive power transmission, for example, where the output pin is connected to an override pin of a corresponding inductive receiver chip.

Where the combined NFC inductive power transfer module includes a common antenna switchable between the NFC reader and the inductive power reception circuit, the controller may further control switching between the antenna and the inductive power receiver.

It is particularly noted that where a separate NFC antenna and secondary inductor are provided, interruption of the inductive transmission signal may be used to reduce interference during the reception of the NFC signal.

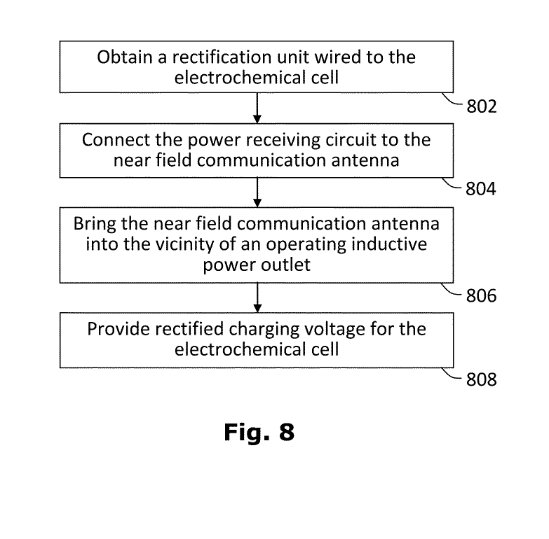

Referring now to the flowchart of FIG. 8, the main steps of a method are presented for charging an electrochemical cell of a communication device. The method functionality of the method may be to rectify the secondary voltage induced in the near field communication antenna, to provide a charging voltage for the electrochemical cell. The mobile communication device for example, comprising a near field communication antenna 120, a near field communication circuit 150, a power receiving circuit 130 and a switching unit 125 that is operable to connect the communication circuit 150 selectively or the power receiving circuit 130 to the near field communication antenna 120.

The method may include the steps of providing, or obtaining from a provider, a rectification unit wired to the electrochemical cell—step 802, connecting the power receiving circuit to the near field communication antenna—step 804 and bringing the near field communication antenna into the vicinity of an operating inductive power outlet—step 806, and provide rectified charging voltage for the electrochemical cell—step 808.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A combined inductive power receiving system for selectively providing at least one of power and communication reception, said combined inductive power receiving system comprising:
at least one inductive power receiver module configured to couple with at least one Near Field Communication (NFC) reader module using a combined communication antenna;
said inductive power receiver module comprising:
a power reception circuit operable to receive power from a secondary inductor and to provide power to an electric load;
a selection switch operable to allow transmission of wireless power from said secondary inductor to said power reception circuit; and
a matching circuit operable to filter transmission of NFC signals to the NFC reader module.

2. The combined inductive power receiving system of claim 1, wherein
said combined communication antenna is operable at a range of frequencies for receiving NFC and power signals concurrently and separately.

3. The combined inductive power receiving system of claim 1, wherein said inductive power receiver module comprises said combined communication antenna.

4. The combined inductive power receiving system of claim 1, wherein said NFC reader module comprises said combined communication antenna.

5. The combined inductive power receiving system of claim 1, wherein said combined communication antenna is configured to split signals of inductive power reception and near field communication transmission.

6. The combined inductive power receiving system of claim 1, wherein said combined communication antenna comprises a single coil common antenna.

7. The combined inductive power receiving system of claim 1, wherein said combined communication antenna comprises:
at least one inductive power receiver secondary inductor; and
at least one near field communication antenna.

8. The combined inductive power receiving system of claim 1, wherein said inductive power receiver module further comprises a control circuit.

9. The combined inductive power receiving system of claim 1, wherein said NFC reader module is externally coupled.

10. The combined inductive power receiving system of claim 1, wherein said NFC reader module operable at an approximately near field communication transmission frequency.

11. The combined inductive power receiving system of claim 1, wherein said range of operable frequencies is between 270 KHz to 360 KHz and 110 KHz to 205 KHz for inductive power reception and near field communication transmission frequency for NFC communication.

12. The combined inductive power receiving system of claim 10 and claim 11, wherein said near field communication transmission frequency is 13.56 MHz.

13. The combined inductive power receiving system of claim 1, wherein said receiving system is configured to block damaging signal transmission to NFC circuit by isolating the NFC circuit or by adding filters.

14. The combined inductive power receiving system of claim 1, wherein said selection switch is integrated into the NFC reader module.

15. The combined inductive power receiving system of claim 1, wherein said selection switch connecting said combined communication antenna outputs is operable to select manually between communication operation mode and power receiving operation mode.

16. The combined inductive power receiving system of claim 1, wherein said selection switch comprises a passive selection switch connected to said combined communication antenna outputs operable to control said inductive power reception and said NFC reader.

17. The combined inductive power receiving system of claim 2, wherein said selection switch is operable to prevent the NFC signal from reaching the inductive power reception branch via a control signal from said control circuit.

18. The combined inductive power receiving system of claim 8, wherein said control circuit includes a low pass filter the output of which may initiate blocking said selection switch.

19. The combined inductive power receiving system of claim 1, wherein said selection switch is configured to allow transmission of a wireless power signal while blocking NFC signals with higher frequencies such as 13.56 MHz.

20. The inductive power receiving system of claim 1, wherein said matching circuit further comprises a passive circuit configured to decrease inductive power transmission.

21. The inductive power receiving system of claim 1, wherein said matching circuit further comprises tuning elements operable to tune NFC circuit frequency to radio signals.

22. A mobile communication device comprising said inductive power receiving system of claim 1.

23. The mobile communication device of claim 22 incorporated into a device selected from a group consisting of handheld devices, mobile phones, laptop computers, desktop computers, tablet computers, PDAs, and media players.

24. A method for charging an electrochemical cell of a mobile communication device, said mobile communication device comprising a near field communication antenna, a near field communication circuit, a power receiving circuit and a switching unit operable to selectively connect said communication circuit or said power receiving circuit to said near field communication antenna, the method comprising the steps:
providing a rectification unit wired to said electrochemical cell;
connecting said power receiving circuit to said near field communication antenna; and
bringing said near field communication antenna into the vicinity of an operating inductive power outlet;
such that a secondary voltage, induced in said near field communication antenna, is rectified by said rectification unit thereby providing a charging voltage for said electrochemical cell.
